(19) United States
(12) Patent Application Publication
(10) Pub. No.: US 2009/0280326 A1
(43) Pub. Date: Nov. 12, 2009

(54) Process for the Treatment of Metal Coated Particles

(76) Inventors: Thomas Giesenberg, Oberwil (CH); Peter Hänggi, Giffers (CH); Patrice Bujard, Courtepin (CH)

Correspondence Address: JoAnn Villamizar;Ciba Corporation/Patent Department, 540 White Plains Road, P.O. Box 2005, Tarrytown, NY, 10591, US

(21) Appl. No.: 12/226,114

(22) PCT Filed: Apr. 2, 2007
(86) PCT No.: PCT/EP2007/053148

§ 371 Date: Oct. 8, 2008

(30) Foreign Application Priority Data
Apr. 12, 2006 (EP) 06112550.6

(51) Int. Cl. B32B 19/00; B32B 15/02; B05D 3/00; H01B 1/02; C09D 11/02

(52) U.S. Cl. 428/403; 427/535; 427/536; 427/537; 252/500; 106/31.92

(57) ABSTRACT

The present invention relates to a process for the thermal treatment of metal coated particles, to the particles obtainable by the process and to their use for the manufacture of printable electronics, or for EMI shielding.

The present invention relates to a process for the thermal treatment of metal coated particles, to the particles obtainable by the process and to their use for the manufacture of printable electronics, or for EMI shielding.

A plurality of methods of manufacturing layers of silver on copper surfaces are known: J. Electrochem. Soc. India (1967), vol. 16, pages 85-89 compares various aqueous baths for forming tightly adherent and level layers of silver on copper surfaces. The baths contain, for example, ammonia, silver nitrate and sodium thiosulfate.

U.S. Pat. No. 3,294,578 discloses a method of electroless plating of silver onto non-noble metals, such as, for example, aluminum, in which a solution of a silver complex is employed. The solution comprising nitrogen containing compounds acting as complexing agents. Among others, the complexing agents suggested are pyrrolidones, e. g. N-methyl pyrrolidone, amides, e. g. dimethyl formamide, anilines and amines.

EP-A-081183 discloses a method of electroless plating of layers of silver or gold onto surfaces of non-noble metals. In this method, a non-noble metal is contacted with a coating bath. The bath contains a metal complex that is obtainable by reaction of a monovalent silver or gold chloride with hydrochloric acid and with a basic substance capable of forming a complex with silver or gold. The complexing agents indicated more specifically are ammonium salts, amines, amino acids, amides, urea and the derivatives thereof, nitrogen heterocycles, alkaline phosphorus compounds as well as hydrocarbons, halogenated hydrocarbons, alcohols, ethers, ketones, esters, carboxylic acid nitriles and sulfur compounds. Among others copper is indicated for a substrate. As a silver ion source silver chloride was chosen. Appropriate solvents are organic solvents, more specifically aprotic solvents which are inert with regard to the complexing reaction, like for example carbon tetrachloride and particularly acetone.

WO96/17974 discloses a method of forming a silver coating on the surface of a metal, more specifically of coating the copper areas on the hole walls in printed circuit boards, copper being less electropositive than silver. For this purpose, the metal surfaces are contacted with an aqueous solution. The solution contains silver ions and a multidentate complexing agent and has a pH in the range of from 2 to 12. The complexing agents suggested are more specifically amino acids and the salts thereof, polycarboxylic acids, like for example nitrilotriacetic acid, ethylene diamine tetraacetic acid, diethylene triamine pentaacetic acid, N-hydroxyethyl-ethylene diamine tetraacetic acid and N,N,N′,N′-tetrakis-(2-hydroxypropyl)-ethylene diamine, furthermore tartrates, citrates, gluconates and lactates, as well as compounds, like crown ethers and cryptands. Silver is deposited from these solutions by charge exchange reaction. The preferred solutions do not contain halide ions.

WO96/17975 discloses a method of silver plating copper surfaces on printed circuit boards, the method comprising first etching the copper surfaces, a lustrous, smooth surface being formed in the method, and then coating the surfaces with the help of a solution containing silver ions. The silver ions can be utilized in the form of the nitrate, acetate, sulfate, lactate or formiate salts thereof. Silver nitrate is preferably used. If needed, the plating solutions may additionally contain complexing agents, such as e. g. amino acids and the salts thereof, polycarboxylic acids, e. g. nitrilotriacetic acid, ethylene diamine tetraacetic acid, diethylene triamine pentaacetic acid, N-hydroxyethyl-ethylene diamine tetraacetic acid and N,N,N′,N′-tetrakis-(2-hydroxypropyl)-ethylene diamine, furthermore tartrates, citrates, gluconates and lactates, as well as cyclic compounds, like crown ethers and cryptands.

EP-A-797380 discloses a method of improving the solderability of copper surfaces, especially of printed circuit boards, the method comprising applying a layer of silver to the surfaces by charge exchange reaction prior to soldering. The layer of silver is formed by contacting the surfaces with an acid plating solution that contains a silver imidazole complex. The silver ion source preferably used is silver nitrate.

JP-A-06240463 discloses a method of coating fine copper powder with silver the method comprising bringing the metal powder into contact with an aqueous plating solution that contains a silver complex salt formed by the reaction of a silver halide with a complexing agent for copper. Additionally, this solution preferably contains a sulfite acting as a stabilizer as well as a pH adjusting means.

JP-A-05287542 discloses an electroless silver plating bath that contains a silver ion complex as well as a reducing agent, such as e. g. hydrazine. As a consequence silver is not formed by a simple charge exchange reaction with a less noble metal but by reduction with the reducing agent. The silver ion complex used is a complex consisting of a silver halide compound and a complexing agent. The complexing agents used are for example anions of thiosulfate and of sulfite. The pH of the bath is adjusted by means of phosphate.

JP09/302476 discloses an electroless bath for depositing a tin/silver alloy that contains, in addition to non-cyanide compounds of silver ions, non-cyanide tin(II)compounds. Among others bromides and iodides are utilized to stabilize silver ions.

SU-A-501116 discloses a solution for depositing silver onto copper surfaces, said solution containing silver chloride, potassium ferrocyanide, potassium thiocyanate, sodium thiosulfate and ammonium hydroxide. The solution has a pH in the range of from 8 to 10.

JP-A-10130855 discloses non-cyanide silver plating baths that contain acid radicals and/or complexing agents for silver ions. The solutions serve to coat tin or tin alloys. Among others nitrates, sulfites, chlorides, bromides, iodides and thiosulfates are used to act as acid radicals or complexing agents, respectively.

Conductive inks are at the moment based on pure silver flakes, which are expensive. One way of reducing the amount of silver significantly is the use of silver coated copper particles. The way to obtain such a material is to use an electroless deposition of silver on ball-milled copper particles with wet chemistry techniques to get a dense silver film which provides a complete coverage of the copper particle (see, for example, U.S. Pat. No. 5,945,158). However, the surface roughness of the particles is drastically increased which leads to a bad interparticle electrical contact and therefore bad electrical conductivity and high electrical resistance in a printed film. The other problem is the electrical contact at the core-shell interphase—copper core and silver shell.

These two issues are solved by a thermal post-treatment, especially a plasma treatment of silver coated copper particles which were prepared by using wet-chemistry techniques.

Accordingly, the present invention relates to a process for the treatment of metal coated particles, comprising
(A) providing particles, comprising
   (a) a substrate and
   (b) a metal layer on the substrate;
(B) treating the particles with a plasma in a plasma reactor, or treating the particles with a
   hot gas in a fluid bed or hot wall flow reactor, and to the metal coated particles obtainable according to the process.

The treatment promotes, for example, uniform crystallinity and/or coating densification. The rapid melting and solidification for certain metal coated particles can provide enhanced properties associated with the metal coating such as electrical conductivity, barrier properties, binding properties and crystalline surface formation. The short residence times in the reaction zones allow for rapid treatments. Further the processing conditions can be adjusted to selective melt and resolidify and crystallize the surface and near surface of the particles. Moreover, surface leveling can be achieved which results in a uniform surface with minimal defects. In case of silver coated copper particles the thermal treatment leads, for example, to the formation of a mixture of silver and copper on the core (copper) shell (silver) interface and a much smoother particle surface. This leads to an improved electrical contact between the copper core and the silver coating and to an improved interparticle electrical contact which provides a higher electrical conductivity—lower electrical resistance—as compared to untreated silver coated copper particles when used in a conductive ink.

The particles can, in principal, have any form. Preferred substrates are on the one hand spherical particles and on the other hand any high aspect ratio materials, such as platelets (flakes), rod-like materials and fibers. The aspect ratio is at least 2 to 1, especially at least 10 to 1. The term “aspect ratio” refers to the ratio of the maximum to the minimum dimension of a particle.

The foregoing and other features of the invention are hereinafter more fully described and particularly pointed out in the claims, the following description setting forth in detail certain illustrative embodiments of the invention, these being indicative, however, of a few of the various ways in which the principles of the present invention may be employed.

Suitable substrates which can be used as base material, include, for example, spherical, rod-like or platelet-shaped organic and inorganic substrates, such as natural micaceous iron oxide (for example as in WO99/48634), synthetic and doped micaceous iron oxide (for example as in EP-A-068 311), mica (muscovite, phlogopite, fluorophlogopite, synthetic fluorophlogopite, talc, kaolin), basic lead carbonate, flaky barium sulfate, SiO₂, Al₂O₃, TiO₂, glass, ZnO, ZrO₂, SnO₂, BiOCl, chromium oxide, BN, MgO flakes, Si₃N₄, or graphite. Particularly preferred are natural, or synthetic mica, another layered silicate, glass, Al₂O₃, SiO_{z}, especially SiO₂, SiO₂/SiOₓ/SiO₂(0.03≦×≦0.95), SiO_{1.40-2.0}/SiO_{0.70-0.99}/SiO_{1.40-2.0}, or Si/SiO_{z} with 0.70≦z≦2.0, especially 1.40≦z≦2.0, or a polymeric substrate, such as PS latexes, PMMA, or PE, very especially graphite, Cu, Ni, Ag, Au, or Ni.

The treatment of the particles can be done with a plasma in a plasma reactor, or with a hot gas in a fluid bed or hot wall flow reactor, wherein the plasma reactor (torch) is preferred against the fluid bed and hot wall flow reactor. The treatment with a hot gas in a fluid bed or hot wall flow reactor is, for example, described in Fluid Bed Technology in Materials Processing (ISBN 0-8493-4832-3).

The plasma torch is preferably an induction plasma torch. The preferred induction plasma torches for use in the process of the present invention are available from Tekna Plasma Systems, Inc. of Sherbrooke, Quebec, Canada. U.S. Pat. No. 5,200,595, is hereby incorporated by reference for its teachings relative to the construction and operation of plasma induction torches.

The induction plasma torch used in the process is equipped with a powder feeder that operates by entraining the particles in an, upward or downward, stream of gas for transport to the plasma induction torch. In addition, it is also possible to inject the particles as a slurry (e.g. aqueous, organic solvents, such as C₁₋₄ alcohols, ketones, and di-C₁₋₂alkyl ethers) into the plasma reactor. This slurry is atomized at the tip of the injection probe.

In a preferred embodiment of the invention the transport gas is inert, i.e. does not react with the outer surfaces of the particles. Typically, the fluidizing gaseous medium is selected to be compatible with the particles, i.e. does not substantially adversely affect the quality of the particles. Examples of such transport gases are argon, nitrogen, helium, oxygen or mixtures such as dry air or argon/hydrogen and argon/oxygen. Generally, gases such as air, nitrogen, argon, helium and the like, can be used, with air being a gas of choice, where no substantial adverse oxidation reaction of the particles takes place.

The instant particles may also comprise an intermediate coating between the core and the metal coating, which intermediate coating may consist, for example, of one or more layers of a metal or mixed-metal oxide or oxide hydrate.

On metallic flakes, the intermediate layer consists preferably of a metal oxide, or oxide hydrate, such as titanium, zirconium, tin, iron, chromium or zinc oxide, bismuth oxychloride or mixtures thereof. Particularly preferred is a coating of silicon dioxide.

The size of the core particles is not critical per se and can be adapted to the particular use. Generally, the particles have a length from about 1 to 200 μm, in particular from about 5 to 100 μm, and thicknesses from about 0.01 to 5 μm, preferably from 0.1 to 2 μm, in particular 0.1 to 0.5 μm. Particles having a platelet-like shape are understood to be such having two essentially flat and parallel surfaces, with an aspect ratio length to thickness of from about 2:1 to about 1000:1, and a length to width ratio of from 3:1 to 1:1.

The gas flow rate is typically selected to obtain fluidization and charge transfer to the powder. Fine powders require less gas flow for equivalent deposition. It has been found that small amounts of water vapor enhance charge transfer.

The time for contacting the particles is generally a function of the substrate bulk density, thickness, powder size and gas flow rate. Particularly the geometry of the substrate, such as, for example, spheres, flakes, short fibers and other similar particles.

An induction plasma torch includes a reaction zone through which the entrained particles pass. The reaction zone temperature is preferably well above the melting point of the highest melting component of the outer layer of the particles and preferably below the vaporization point of the lowest vaporizing component of the layer to enable a relatively short residence time in the reaction zone. As the particles pass through the reaction zone, the outer surfaces of the particles melt, at least in part. Preferably, the flakes pass through the torch at a flow rate that minimizes interparticle contact and coalescence.

Because the outer surfaces of the particles are melted while entrained in a gas, the obtained particles have a smooth outer surface. After melting, the particles fall through a distance sufficient to permit cooling and at least partial solidification prior to contact with a solid surface or each other. While any of several methods may be used to achieve this result, it has been found convenient to feed the particles having the molten surface while still entrained in the transport gas into a liquid cooled chamber containing a gaseous atmosphere.

If a plasma torch is used the process of the present invention comprises
A) providing particles, comprising
   (a) a substrate and
   (b) a metal layer on the substrate;
(B1) entraining said particles in a stream of gas for transport to a plasma torch;
(B2) creating a plasma in said stream of gas to heat the outer surface of the particles;
(C) permitting said particles to cool; and
(D) collecting said particles.

The metal coated particles obtainable by the process of the present invention are new. Accordingly, the present invention is also directed to metal coated particles obtainable by the process of the present invention.

Preferred substrates (a) are natural, or synthetic mica, another layered silicate, glass, Al₂O₃, SiO_{z}, especially SiO₂, with 0.70≦z≦2.0, especially 1.40≦z≦2.0, or a polymeric substrate, such as polystyrene (PS) latexes, polymethmethacrylate (PMMA), or polyethylene (PE). Particularly preferred substrates (a) are graphite, Cu, Zn, Ag, Au, or Ni.

The metal layer on the substrate (b) consists preferably of Ag, Au, or Pt, or an alloy thereof, with the proviso that the metal of layer (b) is different from the metal of the substrate (a).

Various coating processes can be utilized in forming the metal coating layers. Suitable methods for forming the metal coating layer include vacuum vapor deposition, CVD in a fluidized bed, and electrochemical deposition. Another depositing method is the plasma enhanced chemical vapor deposition (PECVD) where the chemical species are activated by a plasma. Such a method is disclosed in detail in WO02/31058. Preferred are the wet chemical methods which are described in the introductionary part of the description of the present invention, such as, for example, wet chemical methods described in U.S. Pat. No. 5,945,158 and WO02/29132.

If the particles comprise (a) a substrate and (b) a metal layer on the substrate; the layer (b) is preferably deposited by a wet chemical method.

While the particles can, in principal, have any form, preferred substrates are any high aspect ratio materials, such as platelets (flakes), rod-like materials and fibers. The aspect ratio is preferably at least 10 to 1. The term “aspect ratio” refers to the ratio of the maximum to the minimum dimension of a particle.

The plate-like particles (flakes, parallel structures) generally have a length of from 1 μm to 5 mm, a width of from 1 μm to 2 mm, and a thickness of from 10 nm to 2 μm, and a ratio of length to thickness of at least 2:1, the particles having two substantially parallel faces, the distance between which is the shortest axis of the core.

The flakes of the present invention are not of a uniform shape. Nevertheless, for purposes of brevity, the flakes will be referred to as having a “diameter”. The flakes have a thickness of from 10 to 2000 nm, especially from 50 to 1000 nm. It is presently preferred that the diameter of the flakes be in a preferred range of about 1-60 μm with a more preferred range of about 5-40 μm. Thus, the aspect ratio of the flakes of the present invention is in a preferred range of about 2.5 to 625.

The application of the conductive metal layer (b) is effected in a manner known per se, for example in accordance with the wet chemical processes described in U.S. Pat. No. 5,945,158, WO02/29132, S. S. Djokic, Electroless Deposition of Metals and Alloys, The Westaim Corp., 51-133 and reference books, such as Handbuch der Galvanotechnik, H. W. Dettner, Hanser Verlag, 1963. All conventional conductive metals or mixtures of metals can be used for this application. A conductive layer of Ag, Au, or Pt, or an alloy thereof is preferred.

The particles are preferably silver coated silica particles, gold coated silica particles, silver coated PS latexes particles, gold coated PS latexes particles, silver coated mica particles, gold coated mica particles, silver coated graphite particles, gold coated graphite particles, silver coated copper particles, silver coated nickel particles, gold coated copper particles, gold coated silver particles, platin coated gold particles, platin coated silver particles, platin coated copper particles, or platin coated nickel particles.

The manufacture of the metal coated particles is explained in more detail on the basis of silver coated copper flakes, but is not limited thereto.

Copper flakes obtained by physical vapor deposition or ball milled copper flakes can be used as substrate, wherein ball milled copper flakes are preferred for cost reasons. The copper flakes have an average particle diameter in a preferred range of about 1-60 μm with a more preferred range of about 5-40 μm. The average thickness of the copper flakes is in a preferred range of about 10-500 nm and is preferably about 100 to 300 nm. The copper flakes consist of copper, or a copper alloy, such as, for example, a copper zinc alloy.

The copper flakes themselves are commercially available from, for example, Wolstenholme (Copper Super, Copper Ink Lining 3312, Copper Lining and Copper Standard) and Schlenk (Cubrotec® 5000, 6000 and 7000). Especially preferred are copper flakes having an average diameter below 20 μm.

The silver coating is preferably done by known wet chemical processes. Reference is made, for example, to the processes described in the introductionary portion of the present invention. The following processes are preferred according to the present invention: In the process described in U.S. Pat. No. 5,945,158 the copper particles are dispersed in an alkaline ammonium salt solution to activate the particle surfaces and remove impurities, or formed copper oxides therefrom. A reducing agent solution, preferably a solution of sodium potassium tartrate, is then added in a sufficient quantity to thereby complex copper ions formed during the activation step, and subsequently reduce the silver ions. A stoichiometric amount of a silver ion-containing solution is added to effect a combined displacement/deposition reaction which because of the presence of the reducing agent is functional to uniformly coat silver onto the copper, or copper coated, particles.

The alkaline ammonium salt solution used to clean and activate the copper surface is ammonium carbonate, ammonium bicarbonate or ammonium sulphate solution. Ammonium sulphate is the preferred salt providing the best coverage of the copper surface and the fastest rate of silver deposition. Under these conditions wherein the copper surface is clean and activated, the displacement reaction takes place rapidly. In order to suppress precipitation of copper hydroxides it is necessary to add a Cu²⁺ ion complexing agent. Sodium potassium tartrate is used and functions as both a complexing agent for the Cu²⁺ ions and subsequently as a mild reducing agent of the silver ions. The concentration of sodium potassium tartrate must be sufficient to complex the Cu²⁺ ions and bring about the reduction of silver ions. In order to produce a uniform silver coating the minimum quantity of sodium potassium tartrate must be at least 65 g per 100 g of copper powder. The silver ion solution is a freshly prepared aqueous solution of silver nitrate and ammonium hydroxide in the molar ratio of 1:3. The amount of silver required in the silver ion solution is dependent upon particle size, the amount of silver decreasing with increasing particle size. The amount of silver required for copper, or copper coated particle sizes ranging between one and six microns would be 50 to 20 weight percent, and 25 to 0.1 weight percent for particle sizes ranging from 6 to 50 microns. The reaction is carried out at ambient temperature. The total time required for the process is about fifteen minutes, the reduction being complete within five minutes. The solution is decanted, and the powder is filtered and washed with deionized water to pH 7 and finally dried at 105° C. The thickness of the obtained silver layer is in the range of from 10 to 50 nm, especially 15 to 30 nm, but is depending on the amount of silver which is deposited and the size of the metal substrate.

As described in WO02/29132 the silver can also be electrolessly plated by charge exchange reaction onto the copper flakes. The bath according to WO02/29132 contains at least one silver halide complex and does not contain any reducing agent for silver(I) ions (Ag⁺). The silver halide complexes contained in the silver plating bath according to WO02/29132 are silver complexes of the type AgₙXₘ wherein n and m represent integers and X is Cl, Br, or I. In general n=1 and m=2, 3 or 4.

The bath contains complex compounds of silver chloride, silver bromide and/or silver iodide acting as silver halide complexes. At least one silver bromide complex is preferably contained. These complexes are formed by the complexing of the corresponding silver (I) ions and halide ions by mixing a silver (I) salt in a solution with a halide salt. Depending on the molarity of the silver (I) ions compound and of the halide compound, complex anions form according to equation:

AgX+nX⁻→AgXₙ₊₁ⁿ⁻

wherein the complex stability increases in the series Cl<Br<I. In the case of halide complexes, the complex anions that preferably form are AgCl₂⁻ and AgCl₃²⁻, in the case of the bromides, the complex anions that preferably form are AgBr₂⁻ and AgBr₃²⁻.

To produce the halide complexes, silver acetate, silver sulfate or silver methane sulfonate may be combined with the alkali halide or the alkaline-earth halide or with the halogen hydracids in a correct stoichiometric ratio (e. g. 1 mole Ag⁺ for 2-3 moles halide) in an aqueous solution, complex anions thereby forming in the process. The concentration of silver may range of from 0.1 to 20 g/l.

The pH of the bath is adjusted to a value in the range of from 0 to 6, preferably of from 2 to 3.0, using acids or bases as pH adjusting means, such as for example the halogen hydracids that correspond to the complex anions, viz. hydrochloric acid, hydrobromic acid and hydriodic acid.

To guarantee as far as possible that even a layer of silver with a reduced thickness does not present any pores, the bath may contain at least one copper inhibitor in addition to the silver complex compounds. By selecting appropriate inhibitors, pores that still exist during the deposition of silver and that open toward the copper surface are closed. In an alternative and even preferred embodiment of the present invention the substrate is contacted with a post-treatment bath containing at least one copper inhibitor. The copper inhibitors which may be used both as a component in the silver plating bath or as a component in the post-treatment bath are preferably selected from the group, comprising triazoles, tetrazoles, imidazoles and pyrazoles. Benzotriazole and tolylbenzotriazole may for example be utilized.

In another preferred embodiment of the invention, the bath according to the invention additionally contains at least one complexing agent for copper(II) (Cu²⁺) ions, like for example ethylene diamine, alanine diacetic acid, amino trimethyl phosphonic acid and 1-hydroxyethylene-1, 1-diphosphonic acid. By using copper complexing agents, formation of gaps and pores in the silver layer is reduced. The bath may additionally contain at least one surface-active agent, such as a polyglycolic ether or an alkyl amine polyglycolic ether.

To prepare the bath, the following steps may for example be performed:

First a silver salt is dissolved in water. Then the resulting solution is heated to accelerate formation of the complex anion. Thereafter an alkali halide and an aqueous halogen hydracid solution are added with stirring. At first, silver halide deposits thereby. This deposit however dissolves again as the halide continues to be added, the complex anion, which is soluble in aqueous solution, forming thereby. Silver deposits on copper surfaces from the bath already at temperatures lower than 20° C. The deposition rate depends on the temperature of the bath and on the silver ion concentration. The operating temperature is preferably adjusted to a value in the range of from 35 to 50° C.

The thickness required for the silver layer is reached in a very short time. A 10 to 50, especially 15 to 30 nm thick silver layer is deposited within 1 to 5 minutes. For this reason, the bath according to the present invention is perfectly suited for horizontal production of printed circuit boards. The choice of the acid and of the pH also determine deposition speed.

To carry out the method in accordance with the invention an electroless silver plating bath containing at least one silver halide complex and not containing any reducing agent for Ag⁺ ions is prepared and thereafter the copper flakes to be coated are contacted with the electroless silver plating bath

Prior to coating the copper surfaces with silver, the copper surfaces may be cleansed and roughened in order to improve adhesion of the silver layers to the substrate. An acid solution containing a surface-active agent may for example be used for cleansing. This is not absolutely necessary though if the copper flakes were not subject to inappropriate handling prior to silver coating. If necessary, the copper flakes are subsequently rinsed to remove remnants of cleansing fluid from the copper surfaces. Then, the copper surfaces are roughened by means of a chemical etch solution. For this purpose, etch solutions, like an acid sodium peroxodisulfate solution or a cupric chloride etch solution may be used. After treatment with the etch solution, the copper flakes are rinsed once more prior to contact with the silver bath. Upon completion of silver coating the copper flakes are rinsed once more and then either post-treated with the post-treatment bath, afterwards rinsed and finally dried or directly dried without post-treatment.

According to galvanic processes or the so called electro-deposition of metals on various substrates, the same chemistry can be used for electroless deposition of reductive surfaces, such as, for example, silver deposition on copper surfaces. As described in the review article of S. S. Djokic, Electroless Deposition of Metals and Alloys, The Westaim Corp., 51-133 and reference books such as Handbuch der Galvanotechnik, H. W. Dettner, Hanser Verlag, 1963, the silver can also be electrolessly plated by charge exchange reaction onto the copper flakes. The bath according to galvanic processes contains at least one silver cyanide complex and does not contain any reducing agent for silver(I) ions (Ag⁺), except the copper of the core. The silver halide complexes contained in the silver plating bath are silver complexes of the type [Ag(CN)₂]⁻. The complexes can be synthesized using different silver salts, such as silver nitrate, silver acetate, silver sulfate, silver citrate etc. and stoichiometric amounts of potassium cyanide, sodium cyanide or other cyanide source in an aqueous solution. The concentration of silver may range of from 0.1 to 20 g/l.

The pH of the bath is adjusted to a value in the range of from 7 to 12, preferably of from 8 to 10, using bases as pH adjusting means, such as, for example, ammonium hydroxide.

To prepare the bath, the following steps may, for example, be performed:

First a silver salt is dissolved in water. Thereafter a potassium cyanide solution in water is added dropwise under stirring until a clear colorless complex solution is formed. Silver deposits on the copper surfaces from the bath already at temperatures lower than 20° C. The deposition rate depends on the temperature of the bath and on the silver ion concentration. The operating temperature is preferably adjusted to a value in the range of from 20 to 50° C.

The thickness required for the silver layer is reached in a very short time. A 10 to 50, especially 15 to 30 nm thick silver layer is deposited within 1 to 5 minutes depending on the amount of silver which is deposited and the size of the metal substrate. The choice of the temperature, the silver ion concentration, stirring speed and adding of the silver ions also determine deposition speed and film formation.

Thereafter, the silver coated copper flakes are subjected to the thermal treatment according to the present invention.

In case of silver coated copper particles the thermal treatment leads to particles comprising
a) a copper core,
b) an intermediate layer of silver and copper, and
c) an outer layer of silver.

Within the intermediate layer the silver content is highest at the interface of the intermediate layer (b) to the silver layer (c) and decreases continually in direction to the copper core (a) (gradient). On the interface of the core (a) and the intermediate layer (b) a mixture of copper and silver is present according to the copper silver phase diagram.

The metal coated particles obtainable according to the process of the present invention can be used for the manufacturing of conductive inks, or paints.

Accordingly, the present invention relates also to a composition, comprising the metal coated particles of the present invention, such as a conductive ink, or a paint.

The composition can be used for the manufacture of printable electronics, or for electromagnetic interference (EMI) shielding.

The conductive ink comprises a vehicle/binder system containing the metal coated particles of the present invention. Such binder systems are, for example, based on vinyl or acrylic resins dissolved in organic solvents. Other known binder systems are, for example, based on epoxy or polyester acrylate systems. Reference is made, for example, to U.S. Pat. No. 5,653,918, WO9945077 and US2005194577.

Paints for EMI shielding for housings of electronic equipment comprise, in principal, an organic binder resin having crosslinkable functional groups; the electrically conductive particles of the present invention, especially silver coated copper flakes; a solvent; an effective amount of a cross-linking agent which cross-links with itself and with the functional groups of the organic binder resin; and a catalyst to accelerate crosslinking of the organic binder resin with the cross-linking agent. Such a paint is, for example, described in WO00/11681, which is incorporated herein by reference.

Accordingly, the present invention relates also to products, comprising the metal coated particles of the present invention, such as heating paths for windscreens, circuit boards, keyboard inlays, antennas of Radio Frequency Identification (RFID) tags and labels, or mobile phone frames.

RFID tags and labels have a combination of antennas, analog and/or digital electronics, and often are associated with software for handling data. RFID tags and labels are widely used to associate an object with an identification code. For example, RFID tags are used in conjunction with security-locks in cars, for access control to buildings, and for tracking inventory and parcels. Some examples of RFID tags and labels appear in RFID Handbook, Fundamentals and Applications in Klaus Finkenzeller, RFID Handbook, Contactless Smart Cards and Indentification, 2^{nd} Edition, Wiley 2004 U.S. Pat. No. 6,107,920, U.S. Pat. No. 6,206,292, and U.S. Pat. No. 6,262,292.

Information is stored on the RFID chip. To retrieve the information from the chip, a “base station” sends an excitation signal to the RFID tag or label. The excitation signal energizes the tag or label, and the RFID circuitry transmits the stored information back to the reader. In general, RFID tags can retain and transmit enough information to uniquely identify individuals, packages, inventory and the like. RFID tags can also be used to store information that is written onto the RFID chip during process, such as temperatures or other data types, and logistical histories. The RFID chip may be a part of a radio-frequency identification transponder that is a part of the RFID tag or label. Radio-frequency identification transponders are widely available in a variety of forms. The antenna for an inlay transponder may be in the form of a conductive trace deposited on a non-conductive support. The antenna has the shape of a flat coil or the like. Leads for the antenna are also deposited, with non-conductive layers interposed as necessary. Memory and any control functions are provided by a chip mounted on the support and operatively connected through the leads to the antenna.

The conductive inks of the present invention can be applied to the substrate by conventional printing methods, especially by screen printing, ink jet printing and flexo printing. Water born flexo and solvent born rotary screen inks are advantageously employed. Water born flexo inks are, for example, based on hydroxy cellulose and solvent born rotary screen inks are, for example, based on nitro cellulose, polyester or terpenol. Typically these formulations have a pigmentation of 30 to 95% by weight and more preferred of 50 to 80% by weight.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

### Example 1

a) 5 g of approximately 10 micron sized copper flakes (Copper Super, Wolstenholme) are suspended in 30 ml ethanol. To this dispersion a solution of 1.16 g ammonium sulphate, 2 ml ammonium hydroxide (25%) and 25 ml water is added. The suspension is stirred for 2 minutes. Afterwards a solution of 4.5 g potassium sodium tartrate and 6.8 g water is added dropwise. After further 10 minutes stirring a solution of 2.1 g silver nitrate, 26 g water and 2.1 ml ammonium hydroxide (25%) is added over 20 minutes to the reaction suspension. The reaction is stirred for 30 minutes. The product is filtered over a glass frit and washed successively with water, ethanol and ethyl acetate. After drying at 60° C. under vacuum, 5 g of a fine greyish powder is obtained. The powder conductivity is determined to be 49,000 S/cm.

b) A powder consisting of the silver coated copper flakes obtained in step 1a) is fluidized in a stream of argon and fed at a rate of 2.6 kg/hour into a plasma reactor with a Tekna PL-70 plasma torch operated at a power of 30 kW. The sheath gas is a mixture of 150 slpm argon and 10 slpm hydrogen [slpm=standard liters per minute; standard conditions for the calculation of slpm are defined as: Tₙ=0° C. (32° F.), Pₙ=1.01 bar (14.72 psi)] and the central gas is argon at 40 slpm. The operating pressure is maintained at slightly lower than atmospheric pressure. The temperature experienced by the silver coated copper flakes is optimized in order to only heat the outer surface of the coating while allowing for the structural solid maintenance of the copper substrate. The degree of heating can be controlled to promote the formation of a mixed layer of silver and copper in between the silver layer and the copper substrate. The treated flakes are collected after passing a heat exchange zone.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A process for the treatment of metal coated particles, comprising
(A) providing particles, comprising
(a) a substrate and
(b) a metal layer on the substrate;
(B) treating the particles with a plasma in a plasma reactor, or treating the particles with a hot gas in a fluid bed or hot wall flow reactor.

2. The process of claim 1, comprising
(A) providing particles, comprising
(a) a substrate and
(b) a metal layer on the substrate;
(B1) entraining said particles in a stream of gas for transport to a plasma torch;
(B2) creating a plasma in said stream of gas to heat the outer surface of the particles;
(C) permitting said particles to cool; and
(D) collecting said particles.

3. The process of claim 1, wherein the layer (b) has been deposited by a wet chemical method.

4. The process of any of claim 1, wherein the substrate (a) is an inorganic, or organic substrate, selected from natural, or synthetic mica, another layered silicate, glass, Al₂O₃, SiO_{z}, SiO₂/SiOₓ/SiO₂(0.03≦×≦0.95), SiO_{1.40-2.0}/SiO_{0.70-0.99}/SiO_{1.40-2.0}, Si/SiO_{z} with 0.70≦z≦2.0, or a polymeric substrate, graphite, Cu, Zn, Ag, Au, and Ni.

5. The process of claim 4, wherein the metal layer on the substrate (b) consists of Ag, Au, or Pt, or an alloy thereof, with the proviso that the metal of layer (b) is different from the metal of the substrate (a).

6. The process of claim 4, wherein the particles are silver coated silica particles, gold coated silica particles, silver coated PS latexes particles, gold coated PS latexes particles, silver coated mica particles, gold coated mica particles, silver coated graphite particles, gold coated graphite particles, silver coated copper particles, silver coated nickel particles, gold coated copper particles, gold coated silver particles, platin coated gold particles, platin coated silver particles, platin coated copper particles, or platin coated nickel particles.

7. A metal coated particle obtained according to the process of claim 1.

8. A conductive ink, or a paint comprising the metal coated particles of claim 7.

9. A product selected from heating paths for windscreens, circuit boards, keyboard inlays, antennas of RFID tags and labels, and mobile phone frames comprising the metal coated particles of claim 7.

10. (canceled)

11. The process of claim 2 wherein the layer (b) has been deposited by a wet chemical method.

12. The process of claim 1, wherein the substrate (a) is an inorganic, or organic substrate, selected from natural, or synthetic mica, another layered silicate, glass, Al₂O₃, SiO₂, SiO₂/SiOₓ/SiO₂(0.03≦×≦0.95), SiO_{1.40-2.0}/SiO_{0.70-0.99/SiO}_{1.40-2.0}, Si/SiO_{z} with 1.40≦z≦2.0, polystyrene latexes, polymethmethacrylate, polyethylene, graphite, Cu, Zn, Ag, Au, and Ni.
